(19) United States
(12) Patent Application Publication
(10) Pub. No.: US 2017/0372635 A1
(43) Pub. Date: Dec. 28, 2017

(54) LEARNING SYSTEM OF CHINESE GRAPHIC CHARACTERS AND INFORMATION PROCESSING METHOD OF OPERATING THE SAME

(71) Applicant: Wen-Hao LIAO, Taipei City (TW)

(72) Inventor: Wen-Hao LIAO, Taipei City (TW)

(21) Appl. No.: 15/404,856

(22) Filed: Jan. 12, 2017

(30) Foreign Application Priority Data
Jun. 28, 2016 (TW) 105120258

(51) Int. Cl. G09B 19/06; G06F 3/0481; G06F 3/0482; G09B 5/02

(52) U.S. Cl. CPC G09B 19/06; G09B 5/02; G06F 3/04817; G06F 3/0482

(57) ABSTRACT

A learning system of Chinese graphic characters and an information processing method of operating the same are disclosed. An electronic apparatus is connected to an information platform provided by a server and the server is connected to an information system building apparatus through an Internet network. The information system building apparatus acquires graphic element information related to graphic characters and relevance between the graphic element information and the graphic characters. The user logs in the information platform of the server by the electronic apparatus. The information platform includes a character search mode and a Chinese character tree mode. The Chinese character tree mode is executed to produce derivative tree information including the plurality of graphic elements, and the character search mode is executed to produce multi-layer graphic explanation information. The results of executing the two modes are rendered to improve efficiency of learning Chinese characters for the user.

### CROSS-REFERENCE TO RELATED APPLICATIONS

This application claims the benefit of Taiwan patent application No. 105120258, filed on Jun. 28, 2016, the disclosure of which is incorporated herein in its entirety by reference.

### BACKGROUND

### 1. Technical Field

The present disclosure relates generally to a character learning system, and more particularly to a learning system of Chinese graphic characters and information processing method of operating the same.

### 2. Description of Related Art

At present, Chinese character application systems are mostly applied for inputting, searching, coding, and word coinage. These kinds of Chinese character application systems are not suitable for learning of Chinese characters since data thus acquired are fragmented and lack systematic processing. The ancient Chinese characters, such as Oracles and Inscriptions, originally belong to the pictogram system. However, after the transformation of Clerical Scripts, the contemporary Chinese characters have lost a large amount of pictographic information of the ancient Chinese characters. Therefore, it is difficult for learners of Chinese characters to realize meanings of parts of Chinese characters due to loss of pictographic information.

The Chinese character application system is constructed based on transitional radicals and parts of Chinese characters. However, the radicals and parts are miscellaneous and lack systematic structures. In general, each Chinese character is composed of basic symbols, referred as to parts, which are obtained from Chinese character components. The basic parts are miscellaneously classified by the counts of strokes thereof since a large amount of more than 500 basic parts lack relevance. For example, [symbol] [symbol] lack of relevance between the basic parts themselves.

Further another conventional Chinese character search system is used to acquire only basic information of Chinese characters, such as radicals, semantic meanings, phonetic symbols, phrase formation, and syntax. However, the search system is incomplete, miscellaneous, and misstructured. Accordingly, it is difficult for learners of Chinese characters to effectively learn Chinese characters by these conventional Chinese character application systems since the Chinese characters are lacking pictographic relevance.

### SUMMARY

In view of the above-mentioned problems in the prior art, the present disclosure provides a learning system of Chinese graphic characters and an information processing method of operating the same. The relevance between the graphic characters and graphic element information thereof is established and stored in a database so that the users can effectively learn Chinese characters in remote sites through an Internet network according to clear, systematic, and structured graphic information.

In order to achieve the above-mentioned objectives, the information processing method for a learning system of Chinese graphic characters is disclosed. A server is connected to a user-side electronic apparatus through a network, and the server provides an information platform having a Chinese character tree mode and a character search mode. The Chinese character tree mode executes steps of:

providing derivative tree information including a plurality of graphic elements;

determining whether an expansion instruction for one of the plurality of graphic elements is received;

producing next-layer derivative tree information of said one of the plurality of graphic elements according to the expansion instruction when the expansion instruction is received;

determining whether a selection instruction for one of the plurality of graphic elements is received when the expansion instruction is not received; and

executing the character search mode to produce multi-layer graphic explanation information when the selection instruction is received.

In this disclosed information processing method, an electronic apparatus is connected to an information platform provided by a server and the server is connected to an information system building apparatus through an Internet network. The information system building apparatus acquires graphic element information related to a plurality of graphic characters and relevance between the graphic element information and the graphic characters stored in a graphic database. The user logs in the information platform of the server by the electronic apparatus. The information platform includes a character search mode and a Chinese character tree mode. The Chinese character tree mode is executed to produce derivative tree information including the plurality of graphic elements, and the character search mode is executed to produce multi-layer graphic explanation information. The results of executing the two modes are rendered to improve efficiency of learning Chinese characters for the user.

In order to achieve the above-mentioned objectives, the learning system of Chinese graphic characters includes:

an electronic apparatus configured to install a browser;

an ancient character database configured to store a plurality of Chinese characters and related part information of the Chinese characters;

an information system building apparatus configured to acquire all information stored in the ancient character database through a network and establish graphic element information related to a plurality of graphic characters and relevance between the graphic element information and the graphic characters; and

a server configured to acquire all information stored in the information system building apparatus; the server comprising a graphic database, a graphic element derivative relationship browser module, and a graphic character search module; the graphic database configured to store graphic element information related to all graphic characters and relevance between the graphic element information and the graphic characters; wherein

when the electronic apparatus is connected to the server, the graphic element derivative relationship browser module of the server is configured to produce derivative tree information including a plurality of graphic elements, and the server is configured to transmit the derivative tree information to the browser of the electronic apparatus;

when the server receives an expansion instruction for one of the plurality of graphic elements, the graphic element derivative relationship browser module is configured to produce next-layer derivative tree information of said one of the plurality of graphic elements, and the server is configured to transmit the next-layer derivative tree information to the browser of the electronic apparatus; and

when the server receives a selection instruction for one of the plurality of graphic elements, the graphic character search module is configured to produce multi-layer graphic explanation information, and the server is configured to transmit the multi-layer graphic explanation information to the browser of the electronic apparatus.

In this disclosed learning system, an electronic apparatus is connected to an information platform provided by a server and the server is connected to an information system building apparatus through an Internet network. The information system building apparatus acquires graphic element information related to a plurality of graphic characters and relevance between the graphic element information and the graphic characters stored in a graphic database. The user logs in the information platform of the server by the electronic apparatus. The information platform includes a character search mode and a Chinese character tree mode. The Chinese character tree mode is executed to produce derivative tree information including the plurality of graphic elements, and the character search mode is executed to produce multi-layer graphic explanation information. The results of executing the two modes are rendered to improve efficiency of learning Chinese characters for the user.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a block diagram of a building system of a preferred embodiment according to the present disclosure;

FIG. 2 is a schematic view of a data structure of the preferred embodiment according to the present disclosure;

FIG. 3 is a first use state view of an information platform of the preferred embodiment according to the present disclosure;

FIG. 4 is a second use state view of the information platform of the preferred embodiment according to the present disclosure;

FIG. 5 is a third use state view of the information platform of the preferred embodiment according to the present disclosure;

FIG. 6 is a fourth use state view of the information platform of the preferred embodiment according to the present disclosure;

FIG. 7 is a fifth use state view of the information platform of the preferred embodiment according to the present disclosure;

FIG. 8 is a flowchart of an information processing method of the preferred embodiment according to the present disclosure;

FIG. 9 is a flowchart of a Chinese character tree mode in the information processing method of the preferred embodiment of the present disclosure according to the present disclosure;

FIG. 10 is a flowchart of a character search mode in the information processing method of the preferred embodiment of the present disclosure according to the present disclosure; and

FIG. 11 is a flowchart of another character search mode in the information processing method of the preferred embodiment of the present disclosure according to the present disclosure.

### DETAILED DESCRIPTION

Reference will now be made to the drawing figures to describe the present disclosure in detail.

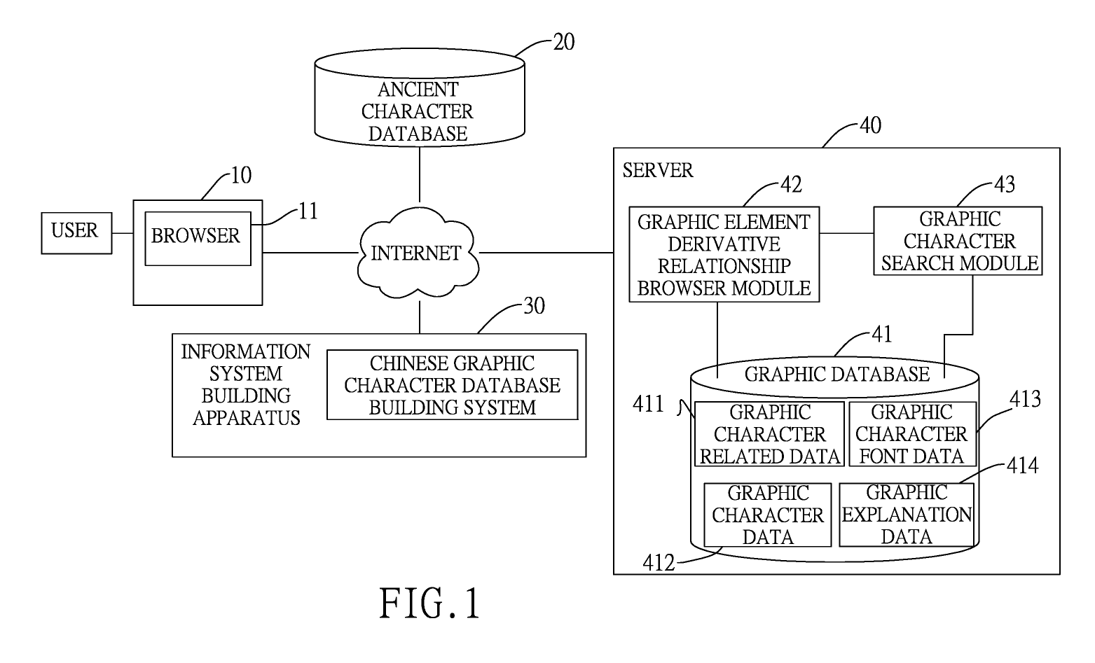

Referring to FIG. 1, a preferred embodiment of a learning system of Chinese graphic characters is disclosed. The learning system includes an electronic apparatus 10 for a user, also referred as to a user-side electronic apparatus, an ancient character database 20, an information system building apparatus 30, and a server 40. The electronic apparatus 10 installs a browser 11. The user operates the electronic apparatus 10 to establish a connection to exchange data with the server 40 through a network, such as an Internet network. Also, the browser 11 renders data for the user. In the present disclosure, the electronic apparatus 10 may be, but not limited to, a computer device, a mobile apparatus, or a portable smart apparatus.

The ancient character database 20 stores a plurality of Chinese characters and related part information of the Chinese characters. In this embodiment, the ancient character database 20 may be provided by an academic institution, such as the Academia Sinica. The information system building apparatus 30 acquires all Chinese characters stored in the ancient character database 20 through the network and establishes graphic element information related to a plurality of graphic characters and relevance between the graphic element information and the graphic characters. In this embodiment, the information system building apparatus 30 may be a computer device, and a Chinese graphic character database building system is built in the information system building apparatus 30.

In general, basic symbols of Chinese characters are referred to as radicals. Each radical of the Chinese characters is originally a graphic symbol with its definite shape and meaning. In this embodiment, each radical of the Chinese characters is converted into a basic graphic symbol with independent meanings based on the Oracles and the Inscriptions. The basic graphic symbols are defined as the graphic elements in this embodiment. Since each Chinese character is composed of radicals, the graphic elements are generated and then graphic characters are generated by the combination of the graphic elements.

The server 40 acquires graphic element information related to all graphic characters and relevance between the graphic element information and the graphic characters stored in the information system building apparatus 30 through the network. The server 40 includes a graphic database 41, a graphic element derivative relationship browser module 42, and a graphic character search module 43. The graphic database 41 stores graphic element information related to all graphic characters and relevance between the graphic element information and the graphic characters. After the graphic database 41 is connected to the server 40, the graphic element derivative relationship browser module 42 of the server 40 produces derivative tree information including a plurality of graphic elements, and then the server 40 transmits the derivative tree information to the browser 11 of the electronic apparatus 10.

The user may operate the browser 11 to analyze a certain graphic character so that the electronic apparatus 10 transmits an expansion instruction of the certain graphic character to the server 40. After the server 40 receives the expansion instruction, the graphic element derivative relationship browser module 42 produces next-layer derivative tree information of said one of the plurality of graphic elements according to the expansion instruction, and then the server 40 transmits the next-layer derivative tree information to the browser 11 of the electronic apparatus 10.

The user may select the graphic character on the browser 11 to directly realize related explanation of the selected certain graphic character. The electronic apparatus 10 transmits a selection instruction for the selected certain graphic character to the server 40. When the server 40 receives the selection instruction for the selected graphic character, the graphic character search module 43 produces multi-layer graphic explanation information, and then the server 40 transmits the graphic explanation information to the browser 11 of the electronic apparatus 10. Accordingly, it is to improve efficiency of learning Chinese characters according to the clear, systematic, and structured graphic explanation information rendered on the browser 11.

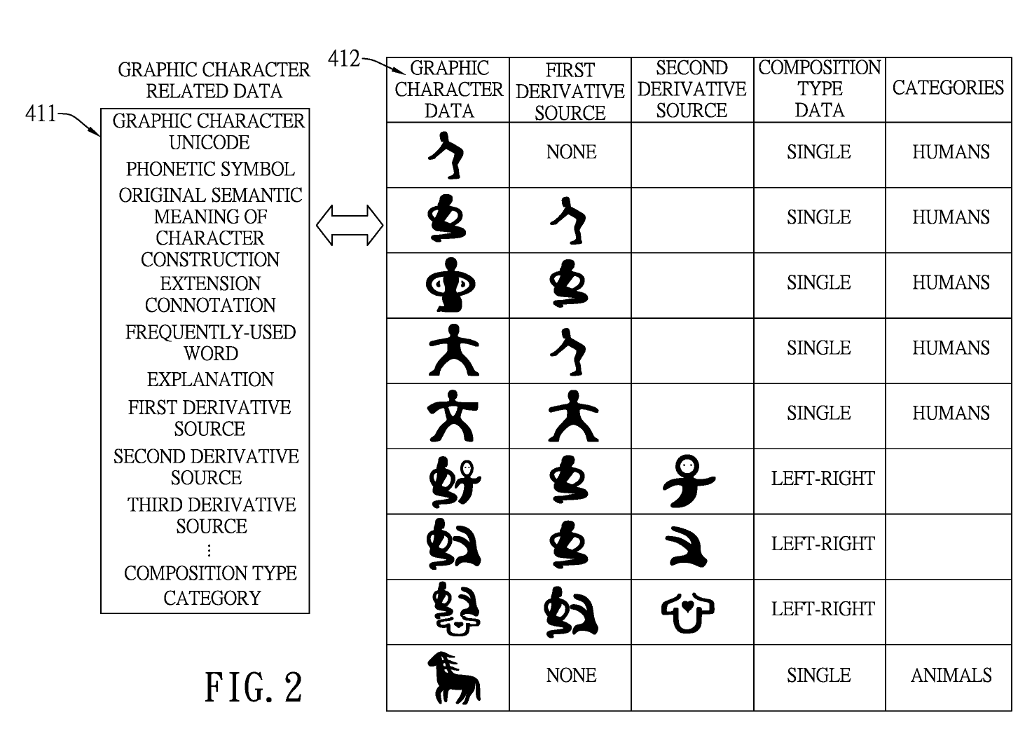

Referring to FIG. 1 and FIG. 2, the graphic database 41 of the server 40 includes graphic character related data 411, graphic character data 412, graphic character font data 413, and graphic explanation data 414. The graphic character related data 411 store all graphic characters and other basic data except for derivative relationship. The graphic character data 412 store related data of each graphic character. As shown in FIG. 2, a data structure of the graphic character related data 411 is corresponding to the graphic character data 412. The data structure of the graphic character related data 411 includes graphic character Unicode, phonetic symbol data, original semantic meaning of character construction data, extension connotation data, frequently-used word data, explanation data, a set of derivative source data, such as a first derivative source, a second derivative source, and a third derivative source, and composition type data.

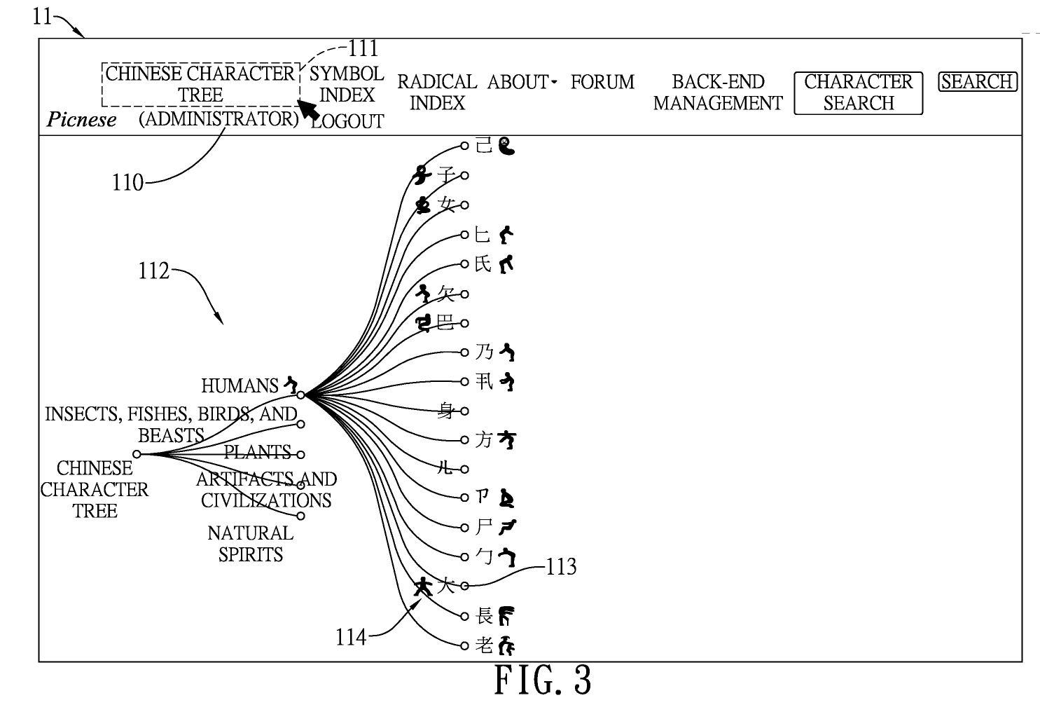

Referring to FIG. 3, the server 40 is connected to the user-side electronic apparatus 10 through the network. Also, the server 40 provides an information platform 110 for users, and the users may log in the information platform 110 through the browser 11 of the electronic apparatus 10. For example, the information platform 110 may be a web-based platform, such as a web page. The information platform 110 provides a Chinese character (Hanzi) tree function key 111. When the user clicks the Chinese character tree function key 111, the graphic element derivative relationship browser module 42 of the server 40 executes a Chinese character tree mode to produce derivative tree information 112 including a plurality of graphic elements. The derivative tree information 112 provided on the information platform 110 includes a plurality of expansion nodes 113 and graphic element information 114 corresponding to the expansion nodes 113.

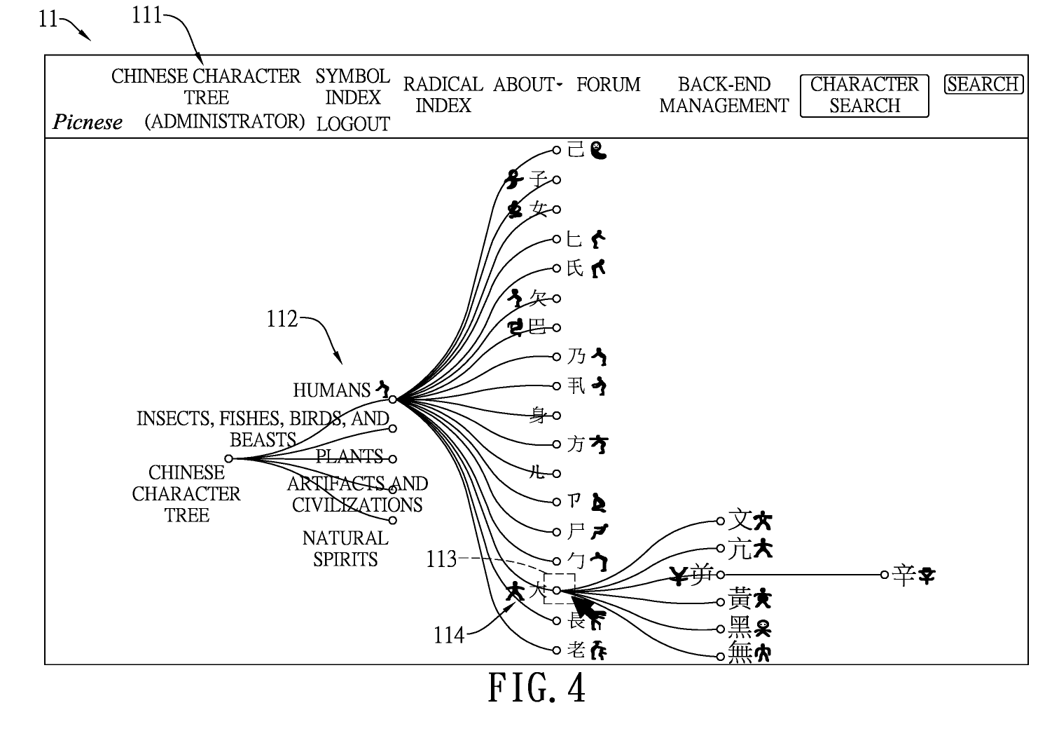

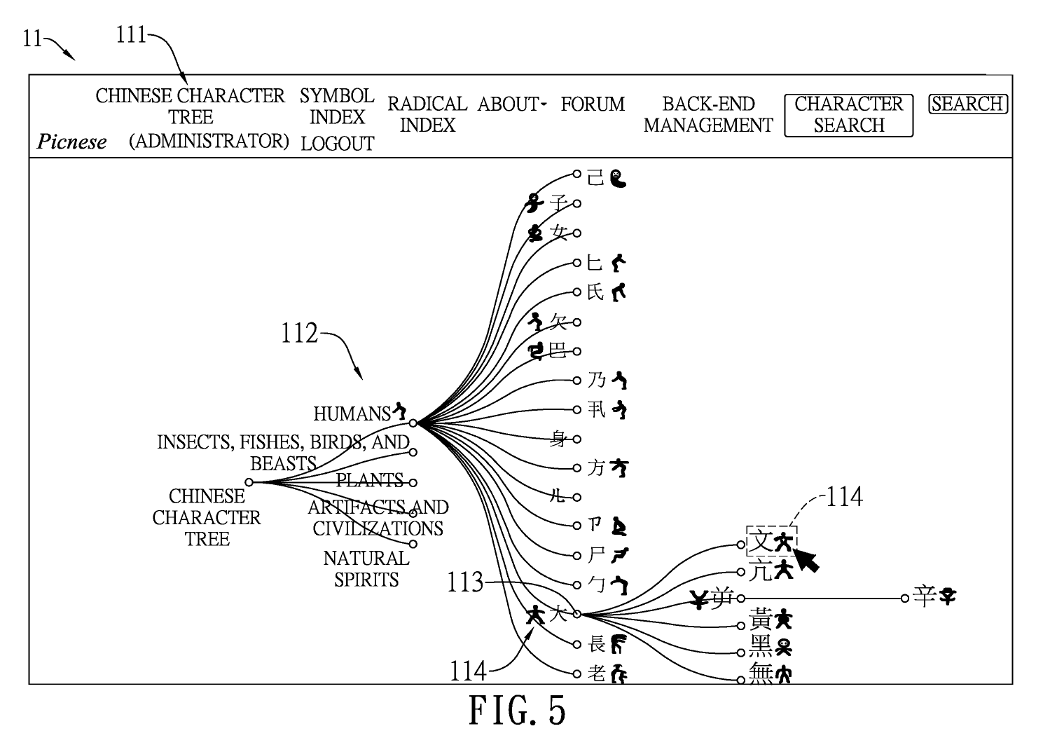

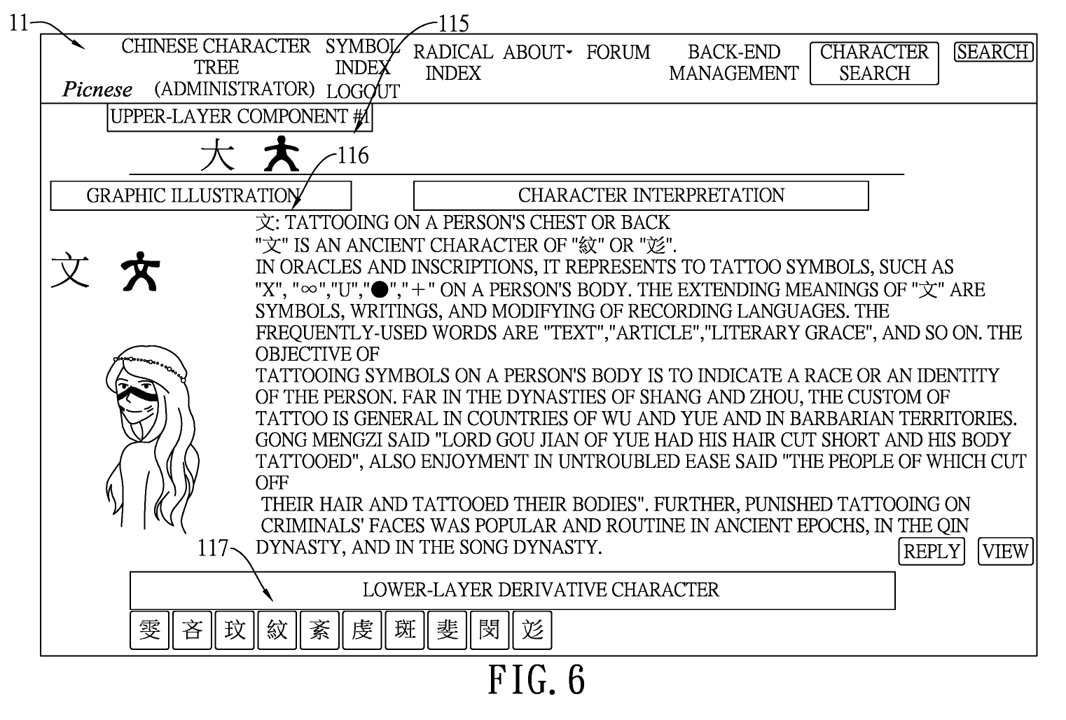

For example, all graphic element information 114 of the derivative tree information 112 may be grouped into five categories, including: (1) humans, (2) insects, fishes, birds, and beasts, (3) plants, (4) artifacts and civilizations, and (5) natural spirits. Each of the five categories may be expanded with multiple layers. Each expansion node 113 of the derivative tree information 112 corresponds to its graphic element information 114. According to search demands, the users may operate the derivative tree information 112 by downward expansion (outward expansion) or upward collapse (inward collapse) of the expansion nodes 113. As shown in FIG. 4, when the user clicks one of the expansion nodes 113 of the derivative tree information 112, the graphic element information 114 related to the selected expansion node 113 outward expands to form a tree-like derived structure through a plurality of derivative lines. As shown in FIG. 5 and FIG. 6, when the user clicks one of the graphic element information 114, the graphic character search module 43 of the server 40 executes a character search mode to produce multi-layer graphic explanation information. The information platform 110 provides the graphic explanation information for the users to inquire basic data, such as original semantic meanings of constructed characters of the graphic element information 114. In this embodiment, the multi-layer graphic explanation information includes upper-layer component information 115, middle-layer graphic illustration information 116, and lower-layer derivative character information 117.

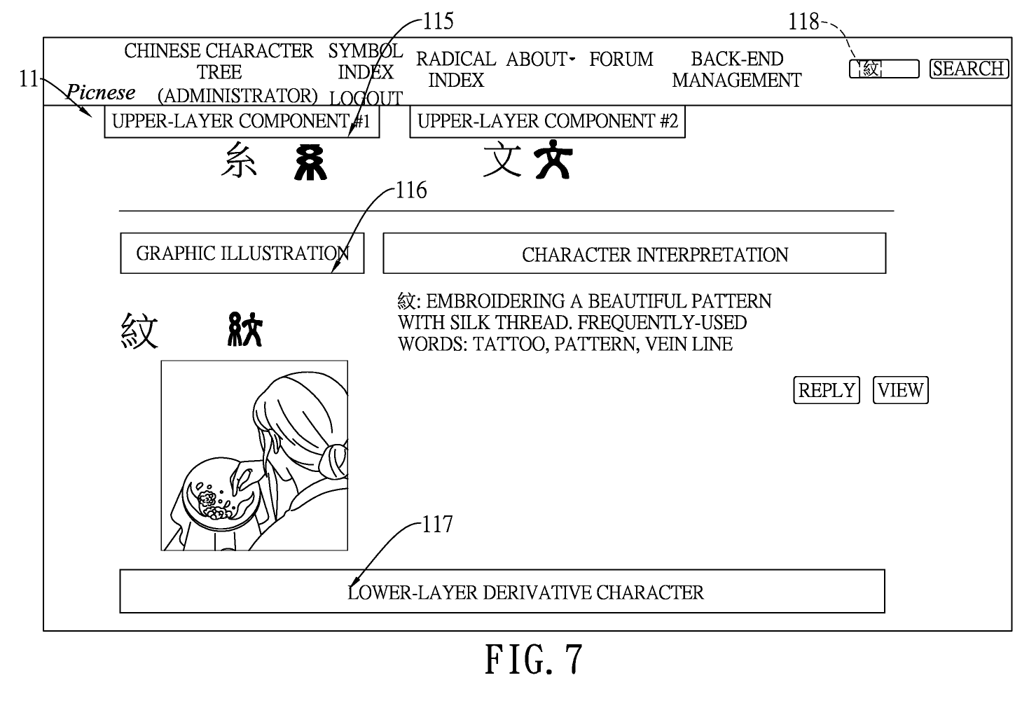

Referring to FIG. 7, the information platform 110 further provides a character search function area 118. When the user enters search character information, such as “ [symbol] ” in the character search function area 118 and clicks a search button, the information platform 110 performs the character search mode to produce another multi-layer graphic explanation information related to the search character information.

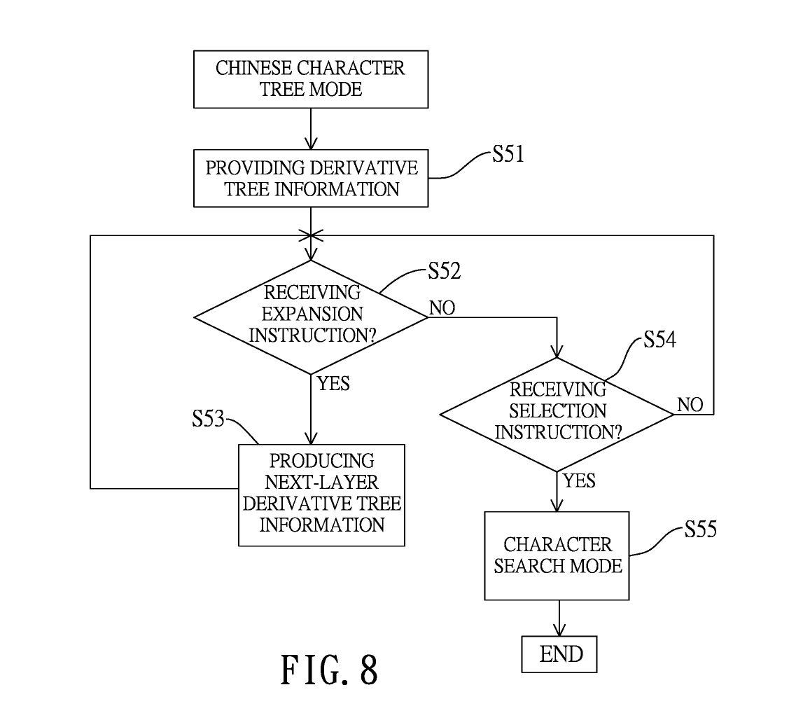

According to descriptions and applications of the above-mentioned embodiments, an information processing method is disclosed. The method is executed or implemented based on a combination of the server 40 and the user-side electronic apparatus 10 connected to the server 40 through the network, such as the Internet network. The server 40 provides an information platform 110, and the information platform 110 has the Chinese character tree mode and the character search mode. Referring to FIG. 8, the Chinese character tree mode executes steps of: providing derivative tree information including a plurality of graphic elements (S51), determining whether an expansion instruction for one of the plurality of graphic elements is received (S52), producing next-layer derivative tree information of said one of the plurality of graphic elements according to the expansion instruction when the expansion instruction is received (S53), determining whether a selection instruction for one of the plurality of graphic elements is received when the expansion instruction is not received (S54), and executing the character search mode to produce multi-layer graphic explanation information when the selection instruction is received or the search character information (S55).

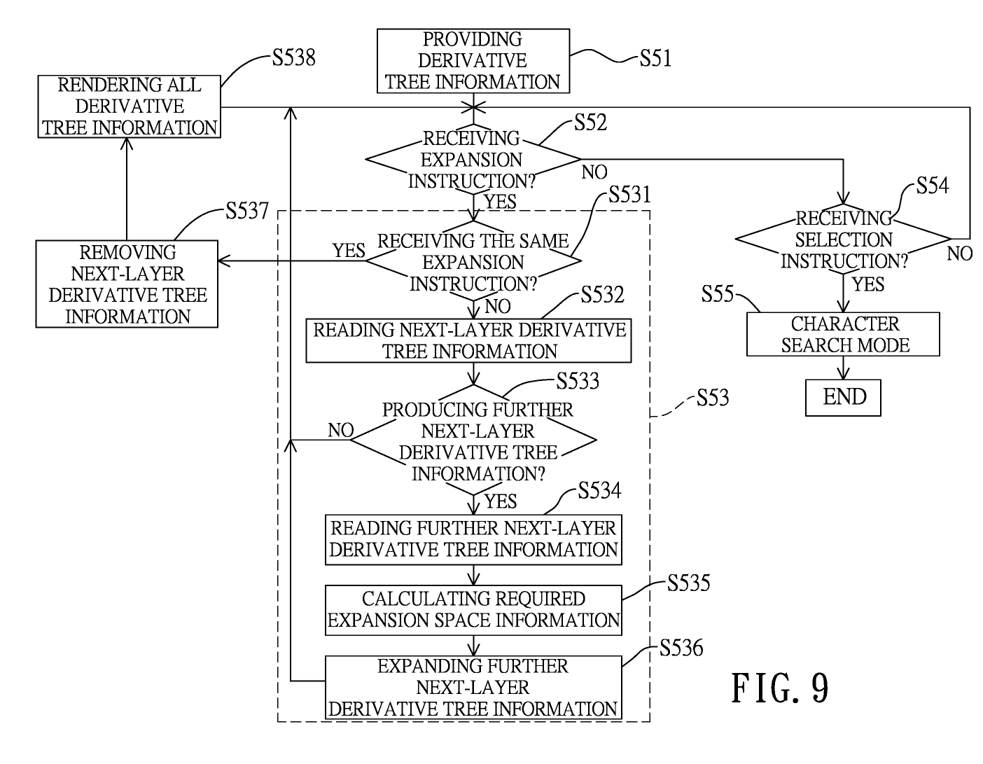

Referring to FIG. 9, the above-mentioned step (S53) further includes steps of: determining whether the expansion instruction for the same graphic element has been received (S531); reading next-layer derivative tree information of the graphic element according to the expansion instruction when the expansion instruction for the same graphic element has not been received (S532); determining whether further next-layer derivative tree information is produced (S533); reading the further next-layer derivative tree information when the further next-layer derivative tree information is produced (S534); calculating required expansion space information according to the further next-layer derivative tree information (S535); and expanding the further next-layer derivative tree information on the information platform 110 according to the required expansion space information (S536).

Referring to FIG. 9, the above-mentioned step (S531) further includes steps of: removing the next-layer derivative tree information that has expanded on the information platform 110 when the expansion instruction for the same graphic element has been received (S537); and calculating another required expansion space information after the next-layer derivative tree information is removed, and rendering all derivative tree information 112 on the information platform 110 according to said another expansion space information (S538).

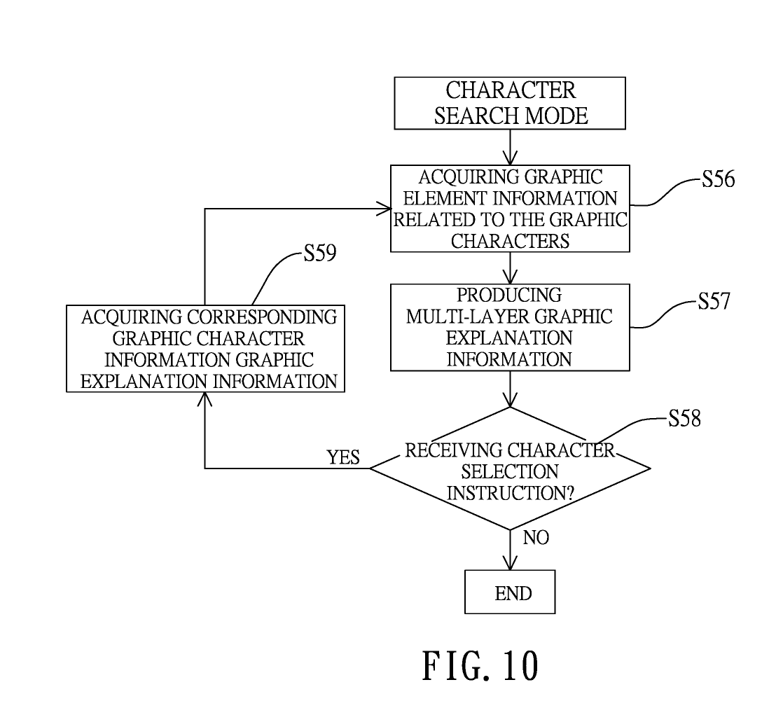

Referring to FIG. 10, the above-mentioned step (S55) further includes steps of: acquiring the graphic element information 114 related to the graphic characters in the graphic database 41 according to the selection instruction or the search character information (S56); producing the multi-layer graphic explanation information and rendering the multi-layer graphic explanation information on the information platform 110 according to the graphic element information 114 related to all the graphic characters and relevance between the graphic element information and the graphic characters (S57); determining whether a character selection instruction is received (S58); and acquiring corresponding graphic character information in the graphic explanation information according to the character selection instruction when the character selection instruction is received (S59). After the corresponding graphic character information is acquired, the step (S56) is executed again.

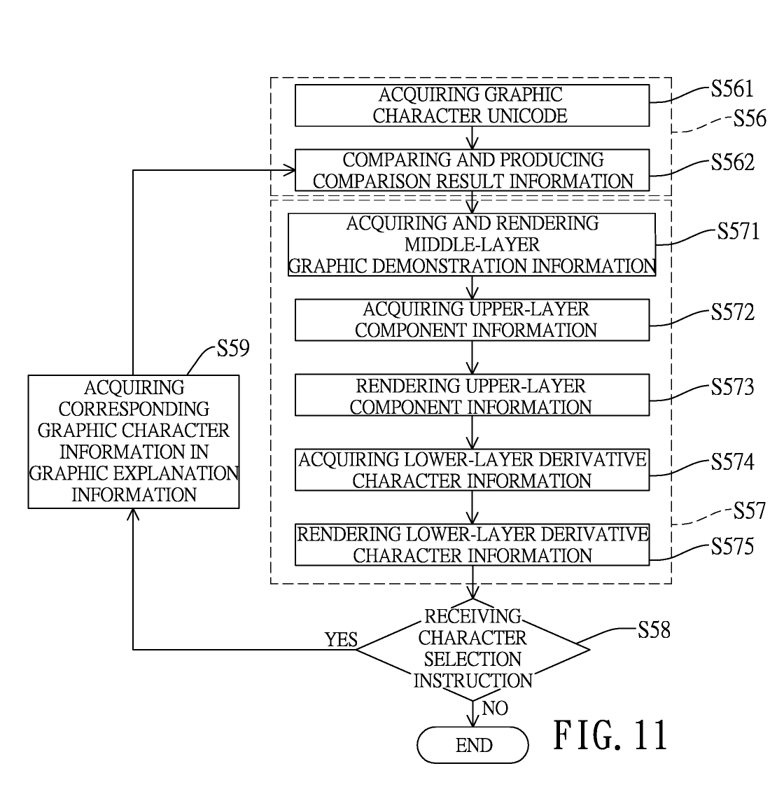

Referring to FIG. 11, the above-mentioned step (S56) further includes steps of: acquiring a graphic character Unicode in the graphic database 41 according to the selection instruction or the search character information (S561); and comparing the graphic character Unicode to all the graphic characters stored in the graphic character related data 411 to produce comparison result information (S562). The comparison result information includes phonetic symbol data, original semantic meaning of character construction data, extension connotation data, frequently-used word data, explanation data, a set of derivative source data, and composition type data. After the step (S562), the step (S57) is executed.

Referring to FIG. 11, the above-mentioned step (S57) further includes steps of: acquiring middle-layer graphic illustration information according to the comparison result information and rendering the middle-layer graphic illustration information on a middle-layer position of the information platform 110 (S571); acquiring upper-layer component information according to the derivative source data in the comparison result information (S572); rendering the upper-layer component information on an upper-layer position of the information platform 110 (S573); acquiring lower-layer derivative character information according to the derivative source data in the comparison result information (S574); and rendering the lower-layer derivative character information on a lower-layer position of the information platform 110 (S575). After the step (S575), the step (S58) is executed.

The disclosed information processing method of operating the learning system of Chinese graphic characters is provided the users to log in the information platform 110 through the browser 11 of the electronic apparatus and to operate the Chinese character tree mode on the information platform 110. The server 40 provides the derivative tree information including the plurality of graphic elements and determines that the user operates the browser to analyze a certain graphic character. The electronic apparatus 10 transmits the expansion instruction of the certain graphic character to the server 40. After the server 40 receives the expansion instruction, the next-layer derivative tree information is produced. Alternatively, after the server 40 receives the selection instruction, the user operates the character search mode to produce the multi-layer graphic explanation information. Accordingly, the Chinese character tree mode and the character search mode are provided for the users to improve efficiency of learning Chinese characters.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. An information processing method for a learning system of Chinese graphic characters, performed by a user-side electronic apparatus and a server connected to the user-side electronic apparatus through a network, wherein the server provides an information platform having a Chinese character tree mode and a character search mode, and the Chinese character tree mode executes steps of:
providing derivative tree information including a plurality of graphic elements;
determining whether an expansion instruction for one of the plurality of graphic elements is received;
producing next-layer derivative tree information of said one of the plurality of graphic elements according to the expansion instruction when the expansion instruction is received;
determining whether a selection instruction for one of the plurality of graphic elements is received when the expansion instruction is not received; and
executing the character search mode to produce multi-layer graphic explanation information when the selection instruction is received.

2. The method as claimed in claim 1, further executing the character search mode to produce another multi-layer graphic explanation information when search character information is received.

3. The method as claimed in claim 1, wherein the step of producing the next-layer derivative tree information of said one of the plurality of graphic elements according to the expansion instruction further includes steps of:
determining whether the expansion instruction for the same graphic element has been received;
reading next-layer derivative tree information of the graphic element when the expansion instruction for the same graphic element has not been received;
determining whether further next-layer derivative tree information is produced according to the graphic element;
reading the further next-layer derivative tree information of the graphic element when the further next-layer derivative tree information is produced;
calculating required expansion space information according to the further next-layer derivative tree information of the graphic element; and
expanding the further next-layer derivative tree information of the graphic element according to the required expansion space information.

4. The method as claimed in claim 3, wherein the step of determining whether the expansion instruction for the same graphic element has been received further includes steps of:
removing the next-layer derivative tree information that has expanded when the expansion instruction for the same graphic element has been received; and
calculating another required expansion space information after the next-layer derivative tree information is removed and rendering all derivative tree information.

5. The method as claimed in claim 1, wherein the step of executing the character search mode to produce multi-layer graphic explanation information when the selection instruction or the search character information is received further includes steps of:
acquiring the graphic element information related to the graphic characters according to the selection instruction or the search character information;
producing the multi-layer graphic explanation information according to the graphic element information related to all the graphic characters and relevance between the graphic element information and the graphic characters;
determining whether a character selection instruction is received; and
acquiring corresponding graphic character information in the graphic explanation information according to the character selection instruction when the character selection instruction is received.

6. The method as claimed in claim 2, wherein the step of executing the character search mode to produce multi-layer graphic explanation information when the selection instruction or the search character information is received further includes steps of:
acquiring the graphic element information related to the graphic characters according to the selection instruction or the search character information;
producing the multi-layer graphic explanation information according to the graphic element information related to all the graphic characters and relevance between the graphic element information and the graphic characters;
determining whether a character selection instruction is received; and
acquiring corresponding graphic character information in the graphic explanation information according to the character selection instruction when the character selection instruction is received.

7. The method as claimed in claim 5, wherein the step of acquiring the graphic element information related to the graphic characters according to the selection instruction or the search character information further includes steps of:
acquiring a graphic character Unicode according to the selection instruction or the search character information; and
comparing the graphic character Unicode to all the graphic characters to produce comparison result information.

8. The method as claimed in claim 6, wherein the step of acquiring the graphic element information related to the graphic characters according to the selection instruction or the search character information further includes steps of:
acquiring a graphic character Unicode according to the selection instruction or the search character information; and
comparing the graphic character Unicode to all the graphic characters to produce comparison result information.

9. The method as claimed in claim 7, wherein the step of producing the multi-layer graphic explanation information according to the graphic element information related to all the graphic characters and relevance between the graphic element information and the graphic characters further includes a step of:
acquiring middle-layer graphic illustration information, upper-layer component information, and lower-layer derivative character information according to the comparison result information.

10. The method as claimed in claim 8, wherein the step of producing the multi-layer graphic explanation information according to the graphic element information related to all the graphic characters and relevance between the graphic element information and the graphic characters further includes a step of:
acquiring middle-layer graphic illustration information, upper-layer component information, and lower-layer derivative character information according to the comparison result information.

11. A learning system of Chinese graphic characters, comprising:
an electronic apparatus having a browser;
an ancient character database configured to store a plurality of Chinese characters and related part information of the Chinese characters;
an information system building apparatus configured to acquire all information stored in the ancient character database through a network and establish graphic element information related to a plurality of graphic characters and relevance between the graphic element information and the graphic characters; and
a server configured to acquire all information stored in the information system building apparatus; the server comprising a graphic database, a graphic element derivative relationship browser module, and a graphic character search module; the graphic database configured to store graphic element information related to all the graphic characters stored in the graphic database and relevance between the graphic element information and the graphic characters; wherein
when the electronic apparatus is connected to the server, the graphic element derivative relationship browser module of the server is configured to produce derivative tree information including a plurality of graphic elements, and the server is configured to transmit the derivative tree information to the browser of the electronic apparatus;
when the server receives an expansion instruction for one of the plurality of graphic elements, the graphic element derivative relationship browser module is configured to produce next-layer derivative tree information of said one of the plurality of graphic elements, and the server is configured to transmit the next-layer derivative tree information to the browser of the electronic apparatus; and
when the server receives a selection instruction for one of the plurality of graphic elements, the graphic character search module is configured to produce multi-layer graphic explanation information, and the server is configured to transmit the multi-layer graphic explanation information to the browser of the electronic apparatus.

12. The learning system as claimed in claim 11, wherein the graphic database further comprises graphic character related data, graphic character data, graphic character font data, and graphic explanation data; the graphic character related data are configured to store all graphic characters and other basic data except for derivative relationship; the graphic character data are configured to store related data of each graphic character.

13. The learning system as claimed in claim 11, wherein the electronic apparatus is a computer device, a mobile apparatus, or a portable smart apparatus; the information system building apparatus is a computer device, and a Chinese graphic character database building system is built in the information system building apparatus.

14. The learning system as claimed in claim 12, wherein the electronic apparatus is a computer device, a mobile apparatus, or a portable smart apparatus; the information system building apparatus is a computer device, and a Chinese graphic character database building system is built in the information system building apparatus.
